(19) United States
(12) Patent Application Publication
(10) Pub. No.: US 2007/0266734 A1
(43) Pub. Date: Nov. 22, 2007

(54) Method for producing glass ceramic articles with an improved surface

(75) Inventors: Bernd Woelfing, Mainz (DE); Ralf Biertuempfel, Mainz-Kastel (DE); Ralf Bonitz, Stadecken-Elsheim (DE); Wolfgang Semar, Mainz-Hechtsheim (DE); Martin Schaefer, Mainz-Kostheim (DE); Michael Hahn, Hohenstein (DE); Nicole Surges, Bingen (DE); Reiner Best, Albig (DE); Thomas Kraus, Stadecken-Elsheim (DE)

Correspondence Address: DEMONT & BREYER, LLC, 100 COMMONS WAY, Ste. 250, HOLMDEL, NJ, 07733, US

(73) Assignee: SCHOTT AG, Mainz (DE)

(21) Appl. No.: 11/746,907

(22) Filed: May 10, 2007

(30) Foreign Application Priority Data
May 16, 2006 (DE) 10 2006 023078.7

(51) Int. Cl. C03C 10/00; C03B 13/00; C03B 25/00; C03B 29/00; C03B 13/16

(52) U.S. Cl. 65/33.9; 65/120; 65/92; 65/284; 65/370.1

(57) ABSTRACT

In order to provide glass ceramic articles with an improved surface with regard to roughness, the invention relates to a method for producing glass ceramic panels (40) in which a green glass panel (10) is produced by hot forming and the green glass panel (10) is subsequently ceramized to form a glass ceramic, wherein the green glass panel (10) is fire-polished on at least one surface (11, 12) before or during the ceramizing.

The invention relates generally to the production of glass ceramic, in particular to measures for reducing the surface roughness.

Glass ceramic plates are widely used for applications such as hot plates or fireproof glass, for example as a window or viewing window for stoves. In particular for use as a window, it is desirable for a glass ceramic plate to be as transparent as possible. Apart from the internal properties of the glass ceramic, the roughness of the surface is of particular importance here.

The hot forming of glass ceramic plates usually takes place from a green glass, which is formed by a rolling process. In this case, a certain roughness is imparted to the surface of the green glass, but may become smoother directly after rolling on account of the high temperature of the glass. However, the given temperature-time profile is not adequate to achieve complete smoothing. Typical roughness values give an average roughness of 0.1 to 0.2 μm.

The invention is therefore based on the object of providing glass ceramic articles with an improved surface with regard to roughness. This object is already achieved in a very surprisingly simple way by the subject matter of the independent claims. Advantageous refinements and developments are specified in the dependent claims.

Accordingly, the invention provides a method for producing glass ceramic panels in which a green glass panel or plate is produced by hot forming and the green glass panel is subsequently ceramized to form a glass ceramic, the panel being fire-polished on at least one surface in an intermediate step.

The green glass panel may in this case also be a continuous ribbon, which is later divided up into individual panels. Accordingly, one embodiment of the invention envisages carrying out the fire polishing directly on a continuous green glass ribbon produced by hot forming.

The fire polishing may in this case be performed on the green glass panel before the ceramizing, during the ceramizing as well as after the ceramizing.

In a further refinement of the invention, the fire polishing is performed before the introduction into an annealing furnace, in which the hot-formed glass panel is cooled in a controlled manner. This is of advantage, since the heating of the panel that in any case goes back to the hot forming process can also be used here for the fire polishing. In the case of a corresponding apparatus for producing an intermediate product for the production of glass ceramic panels or an apparatus for producing glass ceramic panels, an annealing furnace arranged downstream of the hot forming apparatus is accordingly provided, the device for fire polishing being designed for the fire polishing of at least one surface of panels formed with the hot forming apparatus before the introduction into the annealing furnace. The annealing furnace serves for a controlled cooling of the panel to avoid stresses. If the hot forming apparatus is set up for the production of a continuous green glass ribbon and the device for fire polishing is set up for the fire polishing of the green glass ribbon, the device for fire polishing may be arranged in particular between the hot forming apparatus and the annealing furnace, or else be integrated in the annealing furnace.

It has been found to be particularly advantageous if the green glass panel is fire-polished during the cooling that follows the hot forming before a temperature at which nucleation commences is reached. This permits the production of clear, unclouded glass ceramic with a fire-polished surface. If fire polishing is otherwise carried out only after cooling is performed to below this temperature, for example in the annealing furnace to room temperature, the associated renewed heating leads to additional nucleation. The additional nuclei may then cause clouding of the glass ceramic on account of the crystals forming around the nuclei during the ceramizing. A clear or unclouded glass ceramic is in this case understood as meaning not only colorlessly transparent but also colored glass ceramic, such as for instance the bulk-colored glass ceramic with a red to red-brown tint that is often used.

However, the possibility of also using the invention to polish panels that are cooler than the lower temperature at which nucleation commences is not ruled out. This is conceivable for example whenever a clouded, opaque appearance is especially desired, or if the heating is performed so quickly that nucleation is suppressed.

An apparatus according to the invention for producing glass ceramic panels that are suitable in particular for carrying out the present method comprises a hot forming apparatus for producing green glass panels and a ceramizing furnace for ceramizing the green glass panels, as well as a device for fire polishing at least one surface of green glass panels formed with the hot forming apparatus.

In a way corresponding to the particularly preferred refinement of the method according to the invention, in the apparatus the device for fire polishing is preferably arranged so close to the hot forming apparatus along the transporting path of the green glass panels that the glass panels are still hotter than the temperature at which nucleation commences during cooling.

Green glass production and ceramizing do not necessarily have to be performed in one and the same installation. Accordingly, the invention also relates to a method and an apparatus for producing an intermediate product for glass ceramic production in which a green glass panel is produced by hot forming and the green glass panel is fire-polished on at least one surface, and to an intermediate product that can be produced in this way for the production of glass ceramic panels, comprising a green glass panel fire-polished on at least one side. An apparatus for producing an intermediate product for the production of glass ceramic panels, in particular by the method according to the invention, comprises for this purpose a hot forming apparatus for producing green glass panels and a device for fire polishing at least one surface of green glass panels formed with the hot forming apparatus.

Hot forming, and a hot forming method, are understood for the purposes of the invention as meaning all methods in which the form, or the surface, of a glass melt or of a glass body is changed at a temperature that is so high that softening of the glass adequate to permit the changes in shape takes place. A hot forming apparatus accordingly comprises the devices required for these methods.

It has surprisingly been found with respect to the invention that the smoother surface produced by the fire polishing is also retained in the course of ceramizing, so that the fire polishing can already be performed before the ceramizing, at least before its completion.

The device for fire polishing is preferably designed in such a way that the surface to be polished of the green glass panel becomes hotter than internal regions of the green glass panel. In order to heat the green glass panel during fire polishing in such a way that the surface to be polished of the green glass panel becomes hotter than internal regions of the green glass panel, heating methods which as far as possible heat only the surface of the green glass are therefore preferred. In particular, it is preferred that the heating during the fire polishing is carried out in such a way that the green glass panel remains dimensionally stable. Consequently, subsequent deformation is avoided. In particular, it is then also possible to dispense with laborious aging of the green glass panel to avoid deformations.

Particularly surprisingly, it has been found that an improvement of the surface with regard to roughness is also retained even if the green glass plate is mounted with a fire-polished surface on an underlying support during ceramizing. Although the glass ceramic becomes very soft during the ceramizing, and one would expect the roughness of the underlying support to be transferred to the glass ceramic panel, it is found that a reduced roughness is obtained if the supported side has been fire-polished. Accordingly, it is also envisaged in a development of the invention to fire-polish the green glass panel on both sides.

Heating the surface to be polished with a gas burner is particularly suitable for the fire polishing. Direct contact with the flames can then be advantageously avoided by the use of a porous burner.

Heating the surface to be polished with an electrically heated emitter can also be used for the fire polishing. In particular, the aforementioned methods, and corresponding devices, for heating may also be combined with one another to achieve fire polishing. For example, preheating may be performed with a gas burner, the superficial melting finally being performed with an infrared emitter. In this way it is possible, for example, to use an emitter of lower output or, with a given output, to increase the surface area treated per unit of time, in order to lower the production costs.

Generally, the fire polishing can accordingly comprise the superficial melting of a preheated green glass panel. The green glass panel is in this case preferably preheated to at least 500° C., preferably at least 600° C. This is not only favorable for achieving quicker melting for the fire polishing, but the risk of stress cracks occurring is also reduced.

If the green glass panel has not already been preheated by the hot forming process, the apparatus according to the invention may also be provided with an additional device for preheating the green glass panel, in particular for preheating to a temperature of at least 500° C.

In order to achieve fire polishing, the green glass panel, in particular in the already preheated state for fire polishing, may be superficially heated to at least 900° C., with preference above 1000° C.

With particular preference, the hot forming of the green glass panel also comprises the rolling of a green glass panel, the fire polishing being carried out after the rolling. In the case of an apparatus according to this embodiment of the invention, the hot forming apparatus accordingly comprises a rolling device. As already mentioned at the beginning, rolling is the standard method for producing green glass panels. In this way, the invention can be easily integrated in existing installations. In the production of glass ceramic, rolling offers particular advantages over other hot forming methods, such as floating for example. Although panels produced by floating generally have a smoother surface, only certain glass compositions that can also be ceramized are suitable for this method. By contrast, virtually any desired type of glass can be hot-formed by rolling, so that there are scarcely any restrictions regarding desired glass composition. It is therefore also possible by means of the invention to produce rolled glass ceramic plates of a very high surface quality.

According to one embodiment of the invention, the green glass panel is fire-polished before the introduction into a ceramizing furnace. For this purpose, a device for fire polishing is accordingly arranged downstream of the hot forming zone and arranged upstream of the ceramizing furnace.

According to a further embodiment of the invention, the fire polishing may also be carried out at least partially in a ceramizing furnace. For this purpose, a device for fire polishing the green glass panel is accordingly provided in the ceramizing furnace. For example, an infrared emitter may be made to pass over the surface to be polished of the green glass through a window or an opening. Then, the fire polishing may advantageously also be carried out at least partially during the ceramizing. This is with the idea in mind of carrying out the fire polishing before the nucleation temperature is reached.

A glass ceramic panel that can be produced by means of a method according to the invention or a corresponding apparatus is distinguished in comparison with the panels obtained by previously used production methods by lower roughness of the glass ceramic surface. If, for example, the method according to the invention or the apparatus is used for producing fire-resistant glazing, in particular a stove viewing window or fireproof glazing, these products are distinguished by better transparency. However, improved surface quality also yields various esthetic advantages when the invention is used for producing glass ceramic hot plates. In this way, hot plates with a gleaming appearance can be produced.

The invention is explained in more explicit detail below on the basis of preferred embodiments and with reference to the accompanying drawings, in which the same designations refer to the same or equivalent parts and in which:

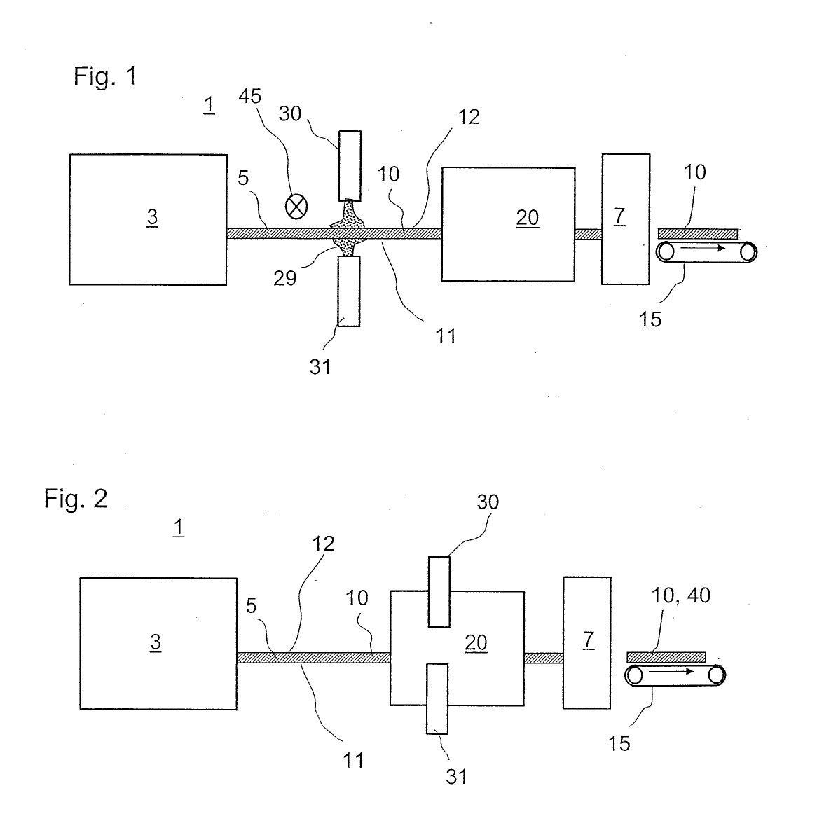

FIG. 1 shows an exemplary embodiment of an apparatus for carrying out the method according to the invention in a schematic view,

FIG. 2 shows a variant of the exemplary embodiment shown in FIG. 1,

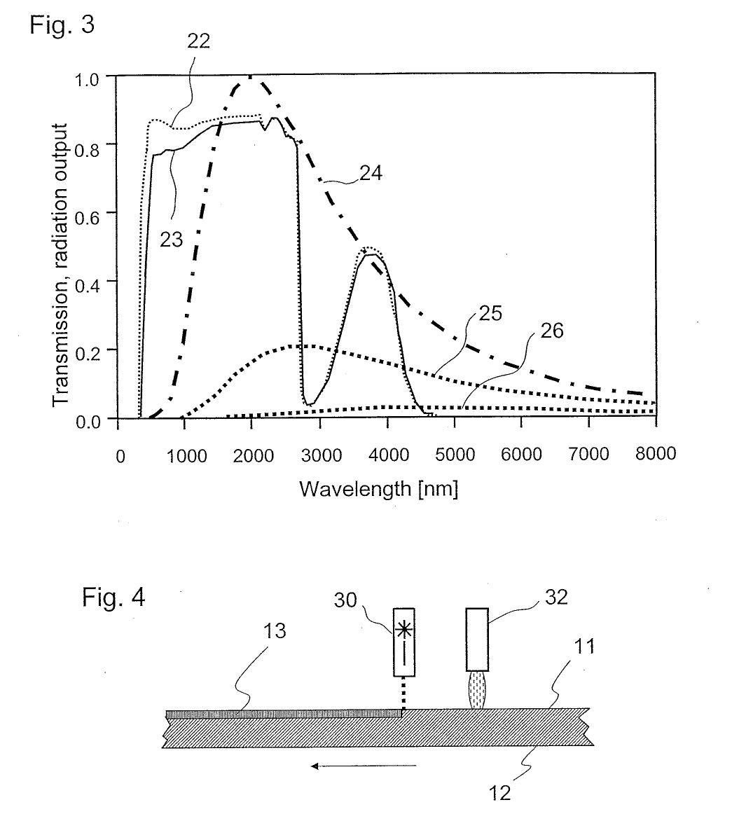

FIG. 3 shows a diagram of the spectral absorption of two types of green glass and spectral variations of the output of a thermal emitter at various temperatures,

FIG. 4 shows method steps according to a development of the invention,

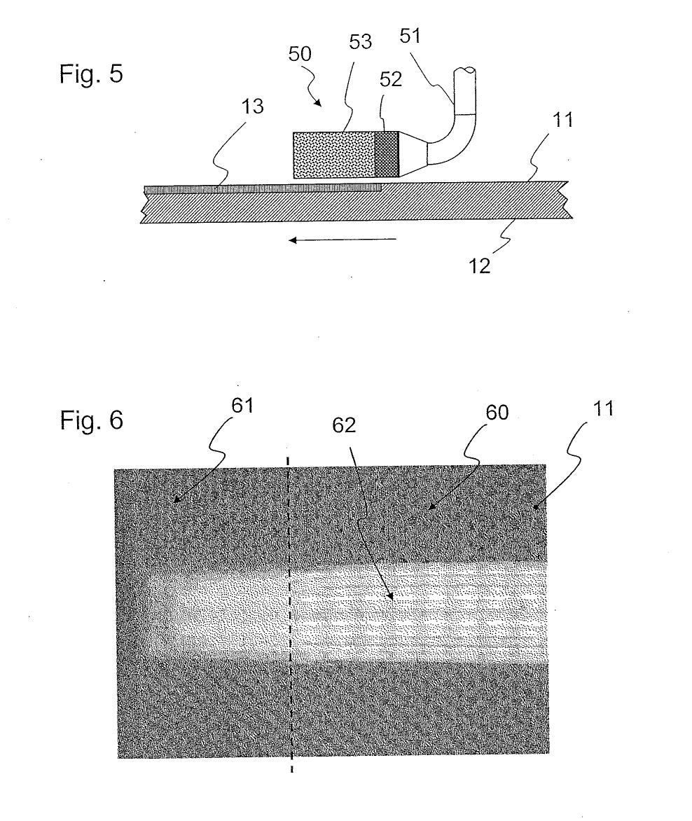

FIG. 5 shows an exemplary embodiment of the invention with a porous burner as a component part of a device for fire polishing, and

FIG. 6 shows a photo of a green glass panel treated according to the invention.

FIG. 1 shows a schematic representation of an apparatus denoted as a whole by the designation 1, for producing glass ceramic panels by means of the method according to the invention, comprising a symbolically represented hot forming apparatus 3 for producing green glass panels and an annealing furnace 20 for annealing the green glass panels, and also a device for fire polishing at least one surface of the green glass panels formed with the hot forming apparatus 3. In this case, firstly a continuous ribbon 5 of the green glass is produced with the hot forming apparatus 3. With preference, the hot forming apparatus 3 for this purpose comprises a rolling device.

In the case of the example shown in FIG. 1, the device for fire polishing comprises two gas burners 30, 31. With the flames 29 of these burners 30, 31, which are made to pass over the surface, the green glass ribbon 5 is fire-polished on both sides, on the opposite surfaces 11, 12.

Subsequently, controlled cooling of the green glass ribbon 5 is performed in the annealing furnace 20, allowing subsequent separation into individual green glass panels 10 by means of a separating device 7. In the case of the example shown in FIG. 1, after the separating device 7 the fire-polished green glass panels 10 are deposited on a transporting belt 15. The green glass panels 10 can then be ceramized in a ceramizing furnace to form glass ceramic plates.

Consequently, an intermediate product for the production of glass ceramic panels is obtained in the form of a green glass panel 10 fire-polished on at least one side, in this case on both sides, on opposite surfaces 11, 12. In the case of the example shown in FIG. 1, therefore the green glass panels 10 are accordingly fire-polished before the introduction into the annealing furnace 20. The fire polishing is in this case carried out in particular before the green glass ribbon 5 reaches an upper temperature at which nucleation commences. In this way, additional nucleation, which may later lead to clouding of the glass ceramic, is avoided.

In an alternative refinement, a ceramizing furnace may also be provided instead of the annealing furnace 20. The fire polishing is then carried out before the introduction of the ribbon 5 or individually separated green glass panels 10 into the ceramizing furnace.

The burners 30, 31 emit infrared radiation at a wavelength of over 10 μm. In this spectral range, the green glass is highly absorbent. Accordingly, the green glass panel is heated during the fire polishing by the burners 30, 31 in such a way that the surface 11 to be polished of the green glass panel becomes hotter than the internal regions of the green glass panel. In particular, virtually nothing but superficial heating is achieved, so that the green glass panel only melts superficially. In this case, the green glass panel 10 is superficially heated to at least 900° C., with preference above 1000° C.

In order to facilitate the melting for the fire polishing, it is of advantage if the fire polishing thereby comprises the superficial melting of a preheated green glass panel 10. Preheating may in particular constitute the heat remaining from the hot forming process. However, an additional preheating device 45 may also be optionally provided. The superficial heating has the effect that the green glass panels 10 also remain dimensionally stable. Preferably, the fire polishing at a temperature of at least 500° C. is performed by the preheating, for example by remaining heating provided by the hot forming process and/or by a separate preheating device 45. Consequently, excessive temperature gradients within the green glass panel 10 are also avoided.

As a difference from the way that is shown in FIG. 1, the fire polishing with the burners 30, 31 may also be performed on the separated glass ribbon 5. However, it is common to both cases that the device for fire polishing with the burners 30, 31 is arranged downstream of the hot forming apparatus 3 and arranged upstream of the ceramizing process.

Heating that is substantially restricted to the surface to be polished, as can be achieved with the burners 30, 31, can only be achieved with difficulty with thermal emitters. In this respect, reference is made to the diagram of FIG. 3, which shows a representation of the spectral variation of the transmission by two types of green glass of the spectral radiation output of thermal emitters for various temperatures. In this diagram, the curves 22 and 23 show spectral variations of the transmission of two different types of green glass, the curve 24 shows the spectral variation of the radiation output of a thermal emitter of a temperature of 1200° C., the curve 25 shows the spectral variation of the radiation output of a thermal emitter of a temperature of 800° C. and the curve 26 shows the spectral variation of the radiation output of a thermal emitter of a temperature of 400° C. As is evident from FIG. 3, for absorption very close to the surface, the radiation should have a wavelength of at least approximately 4.5 micrometers, since the types of green glass become more transparent below these wavelengths, whereas above approximately 4.5 micrometers they are virtually completely absorbent, so that the radiation can scarcely penetrate into the glass. Only with a thermal emitter with a temperature of 400° C. is the average wavelength weighted with the spectral radiation output in the range of 4.5 micrometers. In this case, however, the emitter would already be colder than a green glass preheated to 500° C. Accordingly, with such an emitter, green glass can no longer be heated up to high temperatures for the melting.

With hotter emitters, most of the output is given off at lower wavelengths. If an emitter with a temperature of 1200° C. (curve 24) is used, the maximum of the radiation output is at a wavelength of approximately 2.5 micrometers. In this range, however, the green glass is very transparent, so that regions of the green glass panel that lie further below the surface are also heated up. However, thermal emitters, such as for example electrically heated emitters, may nevertheless be used for example as a preheating device 45, to assist another device for the fire polishing.

FIG. 2 shows a variant of the embodiment of the invention represented in FIG. 1. In the case of this variant, the burners 30, 31 are integrated in the annealing furnace 20. The apparatus 1 shown in FIG. 2 is accordingly equipped with a device for fire polishing the green glass ribbon 5 in the annealing furnace 20. This also makes it possible for the fire polishing to be carried out at least partially during the annealing and/or ceramizing, if the annealing furnace is at the same time formed as a ceramizing furnace, heating devices appropriate for this purpose being provided along the furnace to achieve different temperature zones. For example, the fire polishing may be performed before the nucleation phase or else in the course of the ceramizing. If the green glass is mounted on an underlying support during the ceramizing, this development of the invention is suitable in particular in the case of fire polishing on one side, the upper side of the green glass. In this way it is possible, for instance, to produce glass ceramic panels 40 for hot plates with a smoother upper side.

FIG. 4 shows method steps according to a further embodiment of the invention. In the case of this embodiment of the invention, various methods for the superficial heating of the green glass panel 10 are combined with one another. The green glass panel 10 is in this case taken past a number of devices for heating the panel 10, along the arrow, the devices together representing a device for fire polishing the surface 11 of the panel 10. In the case of the example shown in FIG. 4, the surface 11 of the panel 10 is firstly preheated with one or more gas burners 32. The preheated regions of the surface 11 are then heated further at an infrared emitter 30, the radiation of which is made to pass over the surface 11. In this case, the panel 10 is briefly heated on the surface of the side 11 to above 1000° C., so that the glass melts and a fire-polished surface is obtained. The melted superficial region of the green glass panel 10 is designated by 13.

As a difference from the way that is shown in FIG. 4, one or more gas burners 32 may also be used alone or in conjunction with another heating device as the device for fire polishing. Compared with an emitter 32, higher temperatures and outputs can be achieved more easily with gas burners 32. The gas burner or burners 32 may be used with natural gas, acetylene or hydrogen, as well as mixtures of these substances as fuel gases. In the simplest case, air may be used as the oxidizing agent. For higher temperatures, oxygen may also used as the sole oxidizing agent for enriching air for combustion. Possible unwanted changes of the surface of the green glass panel 10 caused by reducing and/or oxidizing conditions in the flame, and under some circumstances the diffusion into the green glass of water as a combustion product, should however be taken into account. On the other hand, the expenditure on apparatus is less in the case of gas burners.

In order to avoid direct contact of the green glass panel 10 with the flames of a gas burner, a porous burner may advantageously also be used as a device for indirect heating. An exemplary embodiment of a device for fire polishing with a porous burner as a variant of the exemplary embodiment represented in FIG. 4 is shown by FIG. 5. The green glass substrate 10 is moved past a porous burner 50 along the advancing direction identified by the arrow, the surface 11 that is to be polished facing the porous burner 50.

The porous burner 50 comprises a gas supply, with which fuel gas is supplied to a fine-pored material 52. In this material, a preheating of the fuel gas takes place. Subsequently, the fuel gas flows through a coarse-pored material 53, in which the combustion takes place. The coarse-pored material 53 gives off combustion heat to the green glass panel 10. The simultaneous heat transfer along the porous material 53 at the same time has the effect that the reaction zone is stabilized and spreads along this material. Consequently, an extensive heating area is achieved for the heating of the green glass panel 10. A porous glass ceramic comes into consideration for example as the coarse-pored material 53. The maximum achievable temperature is generally approximately 1400° C. Achievable thermal outputs per unit area of such a device lie in the range around 1000 kW/m². Consequently, adequate heating of the surface 11 can be achieved, since it is substantially the case with a porous burner that the heat cannot flow laterally along the surface 11 in the green glass panel on account of the extensive heating area. Consequently, the heat can substantially only flow away perpendicularly to the surface 11 into the panel 10. Moreover, preheating at a high temperature on account of the preceding hot forming process can be used.

FIG. 6 shows a photograph of the surface of a green glass panel 10 treated according to the invention. The photographed surface 11 has in this case been partially fire-polished by means of a gas burner. The region 60 fire-polished with the burner and an adjacent untreated region 61 can be clearly distinguished. The boundary between the regions 60, 61 is clearly indicated here by a depicted dashed line. In particular on the basis of a light reflex 62, it is found that the surface in the fire-polished region 60 is much smoother than in the untreated region 61. The untreated region, as obtained by rolling during the hot forming, appears matt in comparison with the fire-polished region 60. By contrast, the periphery of the light reflex on the fire-polished region 60 is sharper and streaks that originate from the structure of the reflection element of the source of illumination can be seen within the reflex.

It is evident to a person skilled in the art that the invention is not restricted to the embodiments described above by way of example, but rather can be varied in many diverse ways. In particular, the features of the individual exemplary embodiments can also be combined with one another.

1. A method for producing glass ceramic panels, the method comprising:
producing a green glass panel (5, 10) by hot forming; and
subsequently ceramizing the green glass panel (5, 10) to form a glass ceramic;
characterized by fire-polishing the green glass panel (5, 10) on at least one surface (11,12) before or during the ceramizing.

2. The method as claimed in claim 1, wherein a continuous green glass ribbon (5) is produced by the hot forming and the green glass ribbon is fire-polished.

3. The method as claimed in claim 1, wherein the hot forming of the panel (10) comprises the rolling of a panel (10) and the fire polishing is carried out after the rolling.

4. The method as claimed in claim 1, wherein the fire polishing is performed at least partially before the introduction into an annealing furnace.

5. The method as claimed in claim 1, wherein the green glass panel is fire-polished during the cooling after the hot forming before a temperature at which nucleation commences is reached.

6. The method as claimed in claim 1, wherein the green glass panel (10) is heated during the fire polishing in such a way that the surface (11, 12) to be polished of the green glass panel (10) becomes hotter than internal regions of the green glass panel (10).

7. The method as claimed in claim 1, wherein the heating during the fire polishing is carried out in such a way that the green glass panel (10) remains dimensionally stable.

8. The method as claimed in claim 1, wherein the green glass panel (10) is fire-polished on both sides.

9. The method as claimed in claim 1, wherein the fire polishing comprises heating the surface (11,12) to be polished with a gas burner (32).

10. The method as claimed in claim 1, wherein the fire polishing comprises heating the surface (11,12) to be polished with a porous burner (50).

11. The method as claimed in claim 1, wherein the fire polishing comprises the superficial melting of a preheated green glass panel (10).

12. The method as claimed in claim 9, wherein the green glass panel (10) is preheated during the fire polishing to at least 500° C.

13. The method as claimed in claim 1, wherein the green glass panel (10) is superficially heated for fire polishing to at least 900° C.

14. The method as claimed in claim 1, wherein the fire polishing comprises heating the surface (11, 12) to be polished with an electrically heated emitter.

15. The method as claimed in claim 1, wherein the hot forming of the green glass panel (10) comprises the rolling of a green glass panel (10) and the fire polishing is carried out after the rolling.

16. The method as claimed in claim 1, wherein the fire polishing comprises heating the surface (11, 12) to be polished with a porous burner (50).

17. The method as claimed in claim 1, wherein the green glass panel (10) is fire-polished before the introduction into a ceramizing furnace (20).

18. The method as claimed in claim 1, wherein the fire polishing is carried out at least partially in a ceramizing furnace (20).

19. The method as claimed in claim 16, wherein the fire polishing is carried out at least partially during the ceramizing.

20. A method for producing an intermediate product for glass ceramic production, in which the method comprising:
producing a green glass panel (10) by hot forming; and
fire-polishing the green glass panel (10) on at least one surface (11, 12).

21. An apparatus for producing an intermediate product for the production of glass ceramic panels, comprising:
a hot-forming apparatus (3) for producing green glass panels (10); and
a device for fire polishing at least one surface (11, 12) of green glass panels (10) formed with the hot-forming apparatus.

22. The apparatus as claimed claim 21, wherein the hot-forming apparatus (3) is set up for the production of a continuous green glass ribbon (5) and the device for fire polishing is set up for the fire polishing of the green glass ribbon (5).

23. An apparatus (1) for producing glass ceramic panels (40), comprising:
a hot-forming apparatus (3) for producing green glass panels (10); and
a ceramizing furnace (20) for ceramizing the green glass panels (10), having a device for fire polishing at least one surface (11, 12) of green glass panels (10) formed with the hot-forming apparatus (3).

24. The apparatus as claimed in claim 23, wherein the device for fire polishing is designed in such a way that the surface to be polished of the green glass panel (10) becomes hotter than internal regions of the green glass panel (10).

25. The apparatus as claimed in claim 23, wherein the device for fire polishing comprises a gas burner (32).

26. The apparatus as claimed in claim 23, wherein the device for fire polishing comprises a porous burner (50).

27. The apparatus as claimed in claim 23, wherein the hot-forming apparatus comprises a rolling device.

28. The apparatus as claimed in claim 23, wherein the device for fire polishing comprises an electrically heated emitter.

29. The apparatus as claimed in claim 23, having a device for preheating the green glass panel (10), in particular for preheating to a temperature of at least 500° C.

30. The apparatus as claimed in claim 23, having a device for fire polishing the green glass panel (10) on both sides.

31. The apparatus as claimed in claim 23, wherein the device for fire polishing is arranged downstream of the hot-forming apparatus and arranged upstream of the ceramizing furnace (20).

32. The apparatus as claimed in claim 23, having a device for fire polishing the green glass panel (10) in a ceramizing furnace (20).

33. The apparatus as claimed in claim 23, having an annealing furnace arranged downstream of the hot-forming apparatus, the device for fire polishing being designed for the fire polishing of at least one surface of panels formed with the hot-forming apparatus before the introduction into the annealing furnace.

34. An intermediate product for the production of glass ceramic panels, comprising a green glass panel (10) fire-polished on at least one side and produced in accordance with the method of claim 20.

35. A glass ceramic panel (40) with a fire-polished surface produced in accordance with the method of claim 1.

36. The glass ceramic panel as claimed in claim 35, wherein the glass ceramic panel is clear.

37. A method for the production of a hot plate, comprising:
producing a green glass panel (5, 10) by hot forming;
subsequently ceramizing the green glass panel (5, 10) to form a glass ceramic; and
fire-polishing the green glass panel (5, 10) on at least one surface (11,12) before or during the ceramizing.

38. A method for the production of fire-resistant glazing, comprising:
producing a green glass panel (5, 10) by hot forming;
subsequently ceramizing the green glass panel (5, 10) to form a glass ceramic; and
fire-polishing the green glass panel (5, 10) on at least one surface (11,12) before or during the ceramizing.
